(19) United States
(12) Patent Application Publication
(10) Pub. No.: US 2026/0302081 A1
(43) Pub. Date: Oct. 1, 2026

(54) MULTI-LAYER CERAMIC ELECTRONIC COMPONENT

(71) Applicant: TAIYO YUDEN CO., LTD., Tokyo (JP)

(72) Inventor: Kazuki MISAWA, Tokyo (JP)

(21) Appl. No.: 19/567,635

(22) Filed: Mar. 16, 2026

(30) Foreign Application Priority Data
Mar. 31, 2025 (JP) 2025-059362

(51) Int. Cl. H01G 4/30; H01G 4/008; H01G 4/12

(52) U.S. Cl. CPC H01G 4/30; H01G 4/0085; H01G 4/1227

(57) ABSTRACT

A multi-layer ceramic electronic component includes a plurality of dielectric layers stacked along a first axis, and a plurality of internal electrode layers disposed between respective adjacent ones of the plurality of dielectric layers along the first axis. The plurality of dielectric layers include first crystal grains containing a compound that contains an element A and an element B and has a perovskite structure, the compound being represented by a general formula of ABO_{3-α} (0≤α≥1), and second crystal grains containing silicon and the element A, a content ratio of, in terms of amount of substance, the element A relative to silicon being 1.5 or less. The first crystal grains are a main component of the dielectric layers, and the second crystal grains are a sub-component of the dielectric layers. A main component of the plurality of internal electrode layers is a base metal element.

### CROSS-REFERENCE TO RELATED APPLICATIONS

This application claims priority to Japanese Patent Application No. 2025-059362, filed Mar. 31, 2025, the entire content of which is incorporated herein by reference.

### BACKGROUND

### 1. Technical Field

The present disclosure relates to a multi-layer ceramic electronic component.

### 2. Description of Related Art

A multi-layer ceramic electronic component has a structure in which dielectric layers and internal electrode layers are alternately stacked. Examples of the multi-layer ceramic electronic component include a multi-layer ceramic capacitor (MLCC).

Multi-layer ceramic electronic components, such as multilayer ceramic capacitors, are widely used in various electronic devices, including high-frequency communication systems typified by mobile phones and in-vehicle electronic control units. Accordingly, improvements in various performance characteristics are required for multi-layer ceramic electronic components, and numerous studies have conventionally been conducted (see, for example, International Publication No. WO 2006/132086, hereinafter “Patent Document 1”).

### SUMMARY

A multi-layer ceramic electronic component of the present disclosure includes a plurality of dielectric layers stacked along a first axis, and a plurality of internal electrode layers disposed between respective adjacent ones of the plurality of dielectric layers along the first axis. The plurality of dielectric layers include first crystal grains containing a compound that contains an element A and an element B and has a perovskite structure, the compound being represented by a general formula of ABO_{3-α} (0≤α≤1), the first crystal grains being a main component of the plurality of dielectric layers; and second crystal grains containing silicon and the element A, a content ratio of, in terms of amount of substance, the element A relative to silicon being 1.5 or less, the second crystal grains being a sub-component of the plurality of dielectric layers. The plurality of internal electrode layers contain a base metal element as a main component, the main component of the plurality of internal electrode layers differing from the main component of the plurality of dielectric layers.

### BRIEF DESCRIPTION OF THE DRAWINGS

FIG. 1 is a partial cross-sectional perspective view illustrating a multi-layer ceramic capacitor according to an aspect of the present disclosure;

FIG. 2 is a cross-sectional view illustrating a multi-layer ceramic capacitor according to an aspect of the present disclosure;

FIG. 3 is a cross-sectional view illustrating a multi-layer ceramic capacitor according to an aspect of the present disclosure;

FIG. 4 is a cross-sectional view illustrating the details of an element according to an aspect of the present disclosure;

FIG. 5 is an explanatory view of a core-shell structure of a first crystal grain;

FIG. 6 is a flowchart of a method of manufacturing a multi-layer ceramic capacitor according to an aspect of the present disclosure; and

FIGS. 7A and 7B are views illustrating a method of manufacturing a multi-layer ceramic capacitor according to an aspect of the present disclosure.

### DETAILED DESCRIPTION

As described above, multi-layer ceramic electronic components are used in various electronic devices, and various performance improvements are required. In particular, in recent years, there has been a demand for multi-layer ceramic electronic components to reduce the incidence of failures caused by damage to dielectric layers when an electric field is applied at temperatures higher than room temperature. In other words, multi-layer ceramic electronic components having excellent reliability of dielectric layers are increasingly required.

According to the present disclosure, it is possible to provide a multi-layer ceramic electronic component having excellent reliability of dielectric layers.

Embodiments of the present disclosure will be described in detail below, but the present disclosure is not limited thereto. In the present specification and the drawings, components having substantially the same functional configuration are denoted by the same reference numerals, thereby eliminating redundant descriptions. In the drawings, the X-axis, the Y-axis, and the Z-axis, which are mutually orthogonal, are shown as appropriate. The X-axis, the Y-axis, and the Z-axis define a fixed coordinate system fixed to a multi-layer ceramic capacitor, which is an example of a multi-layer ceramic electronic component. The X-axis, Y-axis, and Z-axis can correspond to the length, width, and height of a multi-layer ceramic capacitor, which is an example of a multi-layer ceramic electronic component, when the external shape of the multi-layer ceramic capacitor is a substantially rectangular parallelepiped. Hereinafter, the multi-layer ceramic electronic component according to an embodiment described hereinafter will be described using a multi-layer ceramic capacitor, which is an example of a multi-layer ceramic electronic component.

### [Multi-Layer Ceramic Electronic Component]

### (1) Structure of Multi-Layer Ceramic Electronic Component

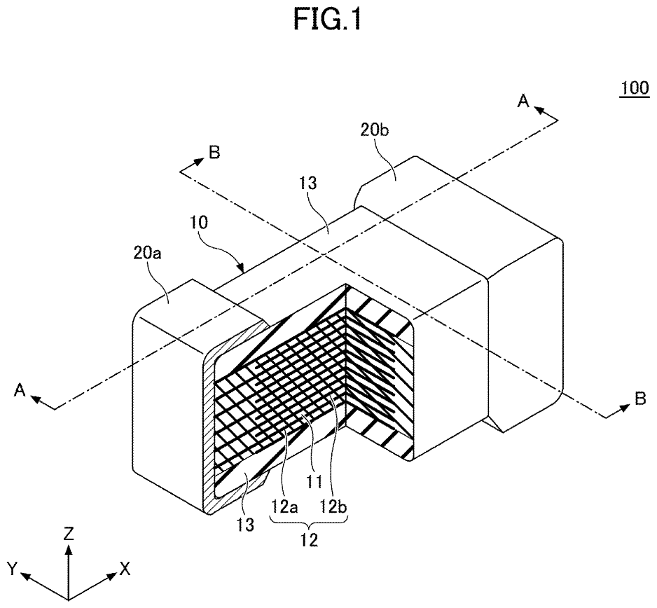

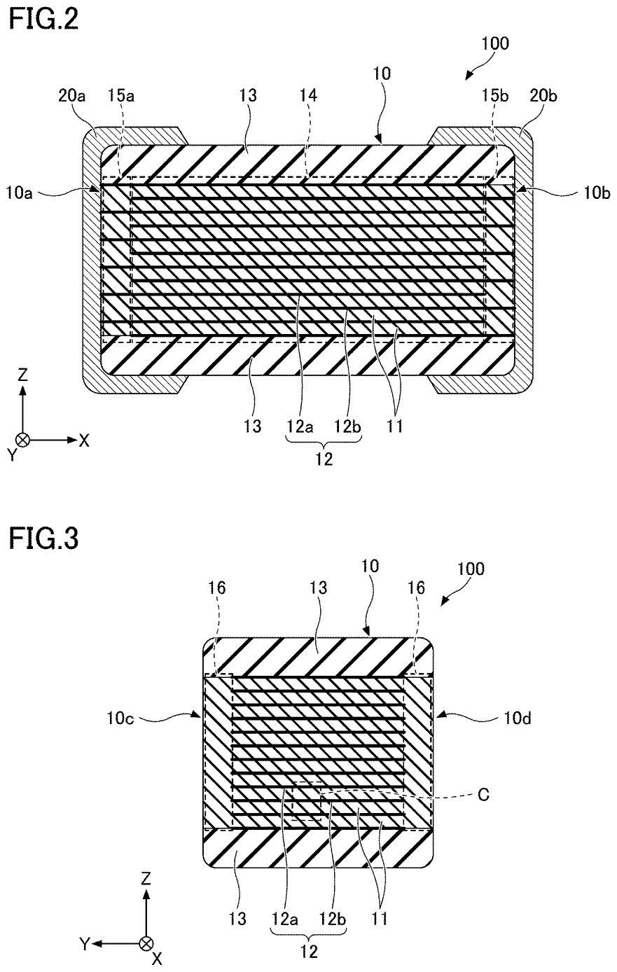

FIG. 1 is a partial cross-sectional perspective view illustrating a multi-layer ceramic capacitor 100. FIGS. 2 and 3 are cross-sectional views illustrating the multi-layer ceramic capacitor 100. FIG. 2 is a cross-sectional view taken along line A-A in FIG. 1. FIG. 3 is a cross-sectional view taken along line B-B in FIG. 1. As illustrated in FIGS. 1 through 3, the multi-layer ceramic capacitor 100 includes an element 10 having a substantially rectangular parallelepiped shape. In the element 10, two opposing surfaces of the element 10 are referred to as an upper surface and a lower surface, and four surfaces connecting the upper surface and the lower surface are respectively referred to as side surfaces. Normally, the surface on the substrate side when a multi-layer ceramic capacitor is mounted on a circuit board is defined as the lower surface; however, the present disclosure need not be limited to this case. In the examples of FIGS. 1 through 3, in the element 10, a first external electrode 20a and a second external electrode 20b are respectively provided on the first side surface 10a and the second side surface 10b (see FIG. 2), which are two opposing side surfaces. The first external electrode 20a extends from the first side surface 10a to four adjacent surfaces. The second external electrode 20b extends from the second side surface 10b to four adjacent surfaces. The first external electrode 20a and the second external electrode 20b are, however, separated from each other. The external electrodes need not be provided on two opposing side surfaces of the element 10 and may be provided on any surfaces of the element 10.

A stacking direction in which dielectric layers 11 and internal electrode layers 12 are stacked may be hereinafter referred to as “the first axis”. In FIGS. 1 through 3, the first axis, which is the stacking direction of the dielectric layers 11 and the internal electrode layers 12, is the Z-axis, which is the direction in which the internal electrode layers 12 face each other.

The axis perpendicular to the first axis, which is the stacking direction, may be hereinafter referred to as “the second axis”. In FIGS. 1 through 3, the second axis perpendicular to the first axis, which is the stacking direction, is the X-axis. The second axis is along the longitudinal direction of the element 10, and is along the direction in which the first side surface 10a and the second side surface 10b of the element 10 face each other or the direction in which the first external electrode 20a and the second external electrode 20b face each other.

The axis perpendicular to the first axis, which is the stacking direction, and perpendicular to the second axis may be hereinafter referred to as “the third axis”. The third axis is along the width of the internal electrode layer 12. In FIGS. 1 through 3, the third axis perpendicular to the first axis, which is the stacking direction, and perpendicular to the second axis is the Y-axis. The third axis is along the direction in which the third side surface 10c and the fourth side surface 10d, which are two side surfaces other than the first side surface 10a and the second side surface 10b among the four side surfaces of the element 10, face each other (see FIG. 3). The X-axis, the Y-axis, and the Z-axis are orthogonal to each other.

The stacking direction is not limited to the direction extending along the Z-axis, but can be any direction. Therefore, for example, the first axis as the stacking direction may be the X-axis or the Y-axis.

In the present specification, for the purpose of describing general embodiments, drawings illustrating a specific embodiment of the general embodiments may be used. However, matters described using the coordinate axis system employed in one embodiment shall be read and applied, in the general embodiments, to a general coordinate axis system in which the stacking direction is defined as the first axis. For example, in FIGS. 1 through 3, in which the stacking direction coincides with the Z direction as a specific embodiment, the axes described as the X-axis, the Y-axis, and the Z-axis are applied to the general embodiments by being read as the second axis, the third axis, and the first axis.

The element 10 has a configuration in which dielectric layers 11 containing a ceramic material functioning as a dielectric, and internal electrode layers 12 are alternately stacked. The internal electrode layers 12 include a plurality of first internal electrode layers 12a and a plurality of second internal electrode layers 12b. The first internal electrode layers 12a and the second internal electrode layers 12b are alternately stacked. The end edges of the first internal electrode layers 12a are extended to the surface of the element 10 on which the first external electrode 20a is provided, i.e., the first side surface 10a in the example illustrated in FIGS. 1 through 3. The end edges of the second internal electrode layers 12b are extended to the surface of the element 10 on which the second external electrode 20b is provided, i.e., the second side surface 10b in the example illustrated in FIGS. 1 through 3. Thus, the first internal electrode layers 12a and the second internal electrode layers 12b are alternately conductive to the first external electrode 20a and the second external electrode 20b. Therefore, the multi-layer ceramic capacitor 100 has a configuration in which capacitor units are stacked. In the stack of the dielectric layers 11 and the internal electrode layers 12, the internal electrode layer 12 is disposed on the outermost layer in the stacking direction, and the outer surface of the stack in the stacking direction, i.e., the upper surface and the lower surface in the examples illustrated in FIGS. 1 through 3, are covered with cover layers 13, respectively. The cover layers 13 contain a ceramic material as a main component. For example, the cover layers 13 may have the same composition as the dielectric layers 11 or may have a different composition. The multi-layer ceramic capacitor 100 is not limited to the structure illustrated in FIGS. 1 through 3 as long as the first internal electrode layers 12a and the second internal electrode layers 12b are exposed in different regions of the surface of the stack and are conductive to different external electrodes. The different regions of the surface of the stack may be surface regions of opposing surfaces of the stack, surface regions of adjacent surfaces of the stack, or different surface regions of the same surface of the stack. As long as the different external electrodes are separated from each other, the first internal electrode layers 12a and the second internal electrode layers 12b may extend from a surface exposed in the surface region of the stack to another surface.

The dimensions of the multi-layer ceramic capacitor 100 are not particularly limited, but may be, for example, 0.25 mm in length, 0.125 mm in width, and 0.125 mm in height; 0.4 mm in length, 0.2 mm in width, and 0.2 mm in height; 0.6 mm in length, 0.3 mm in width, and 0.3 mm in height; 1.0 mm in length, 0.5 mm in width, and 0.5 mm in height; 3.2 mm in length, 1.6 mm in width, and 1.6 mm in height; or 4.5 mm in length, 3.2 mm in width, and 2.5 mm in height. However, the above-listed dimensions of the multi-layer ceramic capacitor 100 are only exemplary, and the multi-layer ceramic capacitor is not limited to the above-listed dimensions. The dimensions of the multi-layer ceramic capacitor 100 may satisfy the relationship of, for example, length>width≥height, width>length≥height, height>length≥width, or height>width≥length. For example, a length represents a dimension in the X-axis direction, a width represents a dimension in the Y-axis direction, and a height represents a dimension in the Z-axis direction.

As described above, the multi-layer ceramic capacitor 100 of the present embodiment has the plurality of dielectric layers 11 stacked along the Z-axis, which is the first axis, and the plurality of internal electrode layers 12 disposed between adjacent ones of the plurality of dielectric layers 11 along the first axis. Hereinafter, the dielectric layers 11 and the internal electrode layers 12 will be described.

In the present specification, terms such as “first” and “second” may be prefixed to member names, such as “first internal electrode layer” and “second internal electrode layer”, but these terms are used only to distinguish members and to avoid confusion, and do not imply any order, priority, or arrangement. Therefore, when there is no risk of confusion or when collectively referred to, the dielectric layer may simply be referred to as the “internal electrode layer”.

### (2) Dielectric Layers

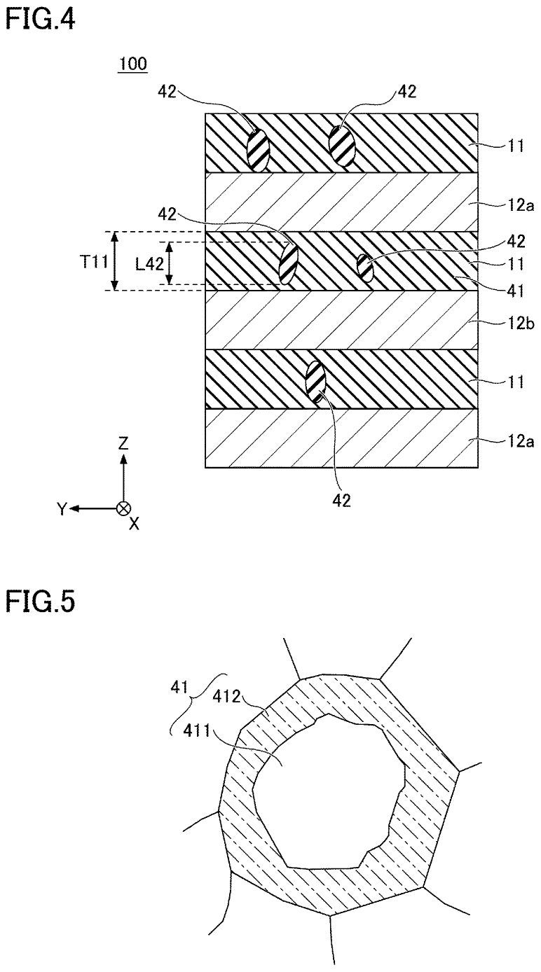

FIG. 4 is an enlarged view of some of the dielectric layers 11 and some of the internal electrode layers 12 of the element 10. FIG. 4 is, for example, an enlarged view of region C in FIG. 3.

As illustrated in FIG. 4, the dielectric layers 11 can include first crystal grains 41 and second crystal grains 42. The dielectric layers 11 can include the first crystal grains 41 as a main component and the second crystal grains 42 as a sub-component. In other words, the dielectric layers 11 can include the first crystal grains 41 in the largest proportion by amount of substance, and the second crystal grains 42 may be included in a smaller amount than the first crystal grains 41.

The number of the first crystal grains 41 in the dielectric layers 11 may be larger than the number of the second crystal grains 42. Since the number of the first crystal grains 41 included in the dielectric layers 11 can be relatively large, the description of individual first crystal grains 41 is omitted in FIG. 4. The first crystal grains 41 can be arranged around the second crystal grains 42 so as to fill the dielectric layers 11.

The first crystal grains 41 contain a compound containing element A and element B and having a perovskite structure, the component being represented by the general formula, ABO_{3-α} (0≤a≤1).

The second crystal grains 42 contain silicon and element A, and the content ratio of, in terms of amount of substance, element A relative to silicon is 1.5 or less. Element A of the first crystal grains and element A of the second crystal grains can be the same element.

### (2-1) Components Contained in Dielectric Layers

### (2-1-1) First Crystal Grains

### (Compound Having Perovskite Structure)

The first crystal grains contain a compound having a perovskite structure as described above. The first crystal grains may be composed of only a compound having a perovskite structure; however, even in such cases, the presence of unavoidable impurities is not precluded.

When a compound having a perovskite structure has a stoichiometric composition, α representing an amount deviating from the stoichiometric composition is 0 and represented by the general formula, ABO₃. A compound having a perovskite structure and represented by the above general formula may have α being greater than 0 and equal to or less than 1. In other words, the compound having a perovskite structure and represented by the above general formula may have oxygen less than the stoichiometric composition.

As a compound having a perovskite structure, one or more compounds selected from barium titanate (BaTiO₃), calcium zirconate (CaZrO₃), calcium titanate (CaTiO₃), strontium titanate (SrTiO₃), magnesium titanate (MgTiO₃), Ba_{1-x-y}CaₓSr_{y}Ti_{1-z}Zr_{z}O₃ (0≤x≤1, 0≤y≤1, 0≤z≤1) having a perovskite structure, and the like can be used.

Ba_{1-x-y}CaₓSr_{y}Ti_{1-z}Zr_{z}O₃ is barium strontium titanate, barium calcium titanate, barium zirconate, barium zirconate titanate, calcium zirconate titanate, or barium calcium zirconate titanate. A compound having a perovskite structure may contain oxygen deficiency in any material.

The dielectric layers 11 preferably contain barium titanate as a compound having a perovskite structure because barium titanate is particularly excellent in dielectric properties, and may contain barium titanate as a main component or may be composed of only barium titanate. Barium titanate has excellent dielectric properties such as extremely high dielectric constant and low dielectric loss. Therefore, when the dielectric layers 11 contain barium titanate as a compound having a perovskite structure, the capacitance of the multi-layer ceramic capacitor 100 can be increased. In the present specification, the phrase “contained as the main component” means that, among the contained components, the component is contained in the largest proportion in terms of amount of substance.

Therefore, the first crystal grains may contain barium titanate as a compound having a perovskite structure.

### (Core-Shell Structure)

The form of the first crystal grains 41 is not particularly limited, but may have a structure consisting of a core portion 411 and a shell portion 412, for example, as schematically illustrated in FIG. 5. The core portion 411 may contain, for example, the compound having the perovskite structure. The shell portion 412 surrounds the core portion 411 and may contain a rare earth element.

The core portion 411 is a crystal portion in which an additive compound is not dissolved or in which the amount of an additive compound dissolved is small. The shell portion 412 is a crystal portion in which an additive compound is dissolved and has a concentration of the additive compound higher than that of the core portion 411. The rare earth element contained in the shell portion 412 is not particularly limited, and at least one kind selected from scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb) can be used. For example, the element concentration of the rare earth element in the shell portion 412 may be higher than the element concentration of the rare earth element in the core portion 411. The shell portion 412 may contain a trace amount of an element other than the rare earth element and the element derived from the compound having the perovskite structure, such as manganese (Mn) and magnesium (Mg), and may contain a trace amount of another element such as molybdenum (Mo). As used herein, the term “trace amount” may mean that a content ratio of the element in question being less than 0.1 with respect to a total amount of substance of elements derived from the compound having the perovskite structure.

The shell portion 412 may be formed by, for example, adding an additive compound containing a rare earth element to a raw material powder used for forming the dielectric layers 11 and firing the mixture to diffuse and solid-dissolve the rare earth element from the surface to the inside of a grain of the compound having the perovskite structure. The thickness of the shell portion 412 can be controlled, for example, by adjusting the amount of an added compound containing rare earth elements, the firing temperature, or other similar factors.

Since the first crystal grain has the core portion 411 and the shell portion 412, the occurrence of a large electrostatic capacitance near the Curie temperature at which the compound having the perovskite structure included in the core portion 411 changes from a ferroelectric phase to a paraelectric phase can be shifted to a low temperature. Therefore, a design in which the electrostatic capacitance is further increased in a practical temperature region near room temperature is possible.

### (2-1-2) Second Crystal Grains

It is considered that the second crystal grains function as a sintering aid when the dielectric layers are fired and sintered. In other words, the second crystal grains can promote densification of the dielectric layers 11.

Although silicon oxide or the like has conventionally been used as a sintering aid for the dielectric layers 11, it sometimes reacts with the compound having the perovskite structure contained in the first crystal grains and extracts a large amount of element A or the like, resulting in instability of the composition of the first crystal grains. When the composition of the first crystal grains included in the dielectric layers 11 becomes unstable, it leads to a decrease in the reliability of the dielectric layers 11.

On the other hand, since the dielectric layers 11 include the second crystal grains 42 containing silicon, in which the content ratio of, in terms of amount of substance, element A relative to silicon is 1.5 or less, the composition of the first crystal grains can be stabilized, thereby improving the reliability of the dielectric layers 11.

In the present specification, “having excellent reliability of the dielectric layer” means that, in the “(1) Evaluation Method” described in the Examples below, the result of the “(1-5) Reliability Test” is rated as A, B, or C, thereby passing the test. In other words, the failure rate when an electric field is applied at 150° C. is low.

In the second crystal grains, a content ratio of element A relative to silicon (A/Si) in terms of amount of substance may be 1.45 or less, 1.2 or less, 1.0 or less, 0.75 or less, or 0.5 or less.

In the second crystal grains, the lower limit of the content ratio of element A relative to silicon in terms of amount of substance is not particularly limited; however, a smaller ratio is preferable. The content ratio may be 0 or more, 0.05 or more, 0.12 or more, or 0.1 or less.

Accordingly, in the second crystal grains, the content ratio of element A relative to silicon in terms of amount of substance may be 0 or more and 1.5 or less; 0.05 or more and 1.45 or less; 0.1 or more and 1.2 or less; 0.12 or more and 1.0 or less; 0.12 or more and 0.75 or less; or 0.12 or more and 0.5 or less.

In addition to silicon and element A, the second crystal grains may also contain one or more kinds of element C selected from manganese and magnesium. The inclusion of element C in the second crystal grains can reduce the incorporation of element A into the second crystal grains. Accordingly, the content ratio of, in terms of amount of substance, element A relative to silicon in the second crystal grains can be reduced to a particularly low level.

The second crystal grains can be represented by, for example, the general formula of AₓC_{y}SiO_{z}, where x can satisfy the content ratio of element A relative to silicon in terms of amount of substance, and may be, for example, 1.5 or less. In the general formula, A represents element A, C represents element C, Si represents silicon, and O represents oxygen. The second crystal grains represented by the above-described composition formula contain only a small amount or substantially no amount of element B contained in the first crystal grains. The term “containing only a trace amount of element B” means that the content ratio of element B relative to element A in terms of amount of substance is less than 0.1, and the term “substantially free of element B” means that the content ratio of element B relative to element A in terms of amount of substance is less than 0.05. When considering that element B is contained in the second crystal grains, the second crystal grains can be expressed by the general formula of AₓBaC_{y}SiO_{z}, for example, and may be 0≤a/x<0.1 or 0≤a/x<0.05.

Although y is not particularly limited, y may be, for example, equal to or greater than 0.1 and equal to or less than 2.2; equal to or greater than 0.3 and equal to or less than 2.0; equal to or greater than 0.6 and equal to or less than 2.0; equal to or greater than 1.2 and equal to or less than 2.0; or equal to or greater than 1.5 and equal to or less than 1.9.

z may be selected in accordance with the contents of element A, element C, and silicon, and may be, for example, within a range of 4±0.2, i.e., equal to or greater than 3.8 and equal to or less than 4.2.

The size of the second crystal grains are not particularly limited, but a length L42 along the first axis may be equal to or greater than one-third of a thickness T11 of the dielectric layer 11 for at least a part of the second crystal grains 42. In other words, the dielectric layers 11 may include the second crystal grains whose length along the first axis is equal to or greater than one-third of the thickness T11 of the dielectric layer 11.

Conventionally, as the size of the second crystal grains derived from the sintering aid increases, the composition of the first crystal grains containing a dielectric becomes unstable, that is, the composition variation increases, and the reliability of the dielectric layers 11 tends to decrease. On the other hand, in the multi-layer ceramic capacitor of the present embodiment, the composition variation of the first crystal grains can be reduced regardless of the size of the second crystal grains. Therefore, in the multi-layer ceramic capacitor of the present embodiment, as the size of the second crystal grains increases, the reliability of the dielectric layers 11 can be enhanced compared with the conventional technology. Therefore, for at least a part of the second crystal grains 42 contained in the dielectric layers 11, the length L42 along the first axis may be one-third or more or half or more of the thickness T11 of the dielectric layer 11.

The upper limit of the length L42 of the second crystal grain 42 contained in the dielectric layer 11 along the first axis is not particularly limited, and may be, for example, equal to or less than the thickness T11 of the dielectric layer 11, or may be, for example, greater than the thickness T11 of the dielectric layer 11. Of the length L42 along the first axis, a portion of the second crystal grain 42 that exceeds the thickness of the dielectric layer 11 may intrude into a part of the internal electrode layer 12, or may penetrate through the internal electrode layer 12.

A method for measuring the thickness T11 of the dielectric layer 11 will be described later.

The length L42 of the second crystal grain 42 along the first axis is evaluated on a cross section including the first axis, which is the stacking direction. For example, from the viewpoint of ease of polishing and measurement, it is preferable to perform the evaluation on either a cross section further including the second axis that is set perpendicular to the stacking direction or a cross section further including the third axis that is set perpendicular to the stacking direction and perpendicular to the second axis. In the former case, the multi-layer ceramic capacitor 100 is polished in the direction of the third axis; in the latter case, the multi-layer ceramic capacitor 100 is polished in the direction of the second axis. The length along the first axis of the second crystal grain 42 included in the dielectric layer 11 can be measured and evaluated on an arbitrary cross section including the exposed first axis.

### (2-1-3) Additive Compounds

The dielectric layer 11 can also contain an additive compound as an optional component.

The additive compound that can be contained in the dielectric layers 11 is not particularly limited, but examples of the additive compound include a compound such as an oxide or a carbonate containing one or more elements selected from zirconium (Zr), magnesium (Mg), manganese (Mn), molybdenum (Mo), vanadium (V), chromium (Cr), and rare earth elements, a compound such as an oxide or a carbonate containing one or more elements selected from cobalt (Co), nickel (Ni), lithium (Li), boron (B), sodium (Na), potassium (K), and silicon (Si), or glass containing one or more elements selected from cobalt, nickel, lithium, boron, sodium, potassium, and silicon.

The rare earth element can be one or more kinds selected from scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb).

### (2-2) Thickness of Dielectric Layer

The thickness of the dielectric layer 11 is not particularly limited, but may be equal to or less than 1.0 μm; equal to or less than 0.8 μm; equal to or less than 0.6 μm; less than 0.6 μm; equal to or less than 0.5 μm; equal to or less than 0.4 μm, for example, from the viewpoint of increasing the number of layers and increasing the capacitance while downsizing the multi-layer ceramic capacitor 100.

The lower limit value of the thickness of the dielectric layer 11 is not particularly limited, but may be as low as two to four times the average diameter of the dielectric material grains to be used from the viewpoint of increasing productivity and yield. For example, if the average diameter of the dielectric material grains to be used is 0.1 μm, the lower limit value of the thickness of the dielectric layer 11 may be equal to or greater than 0.2 μm and equal to or less than 0.4 μm, and the thickness of the dielectric layer 11 may be equal to or greater than 0.2 μm, or equal to or greater than 0.4 μm, for example.

The average diameter of the dielectric material grains may be an average value obtained by measuring the grain size of each dielectric material grain in a cross section including the first axis, which corresponds to the stacking direction of the multi-layer ceramic capacitor 100. For measuring the grain size of the dielectric material grains, an optical microscope, a microscope, a scanning electron microscope (SEM), or the like may be used as appropriate. The grain size of the dielectric material grain may be a Haywood diameter (the diameter of a circle having an area equal to the area of the dielectric material grain to be evaluated) in an observed cross section. The average diameter, which is an average value of the grain sizes of the dielectric material grains, may be an arithmetic average value of the grain sizes of 50 to 200 freely selected dielectric material grains. In the present specification, unless otherwise specified, the average value means an arithmetic average value.

The thickness of the dielectric layer 11 is evaluated on a cross section including the first axis, which corresponds to the stacking direction. For example, from the viewpoint of ease of polishing and measurement, it is preferable to evaluate the thickness on a cross section including the second axis that is set perpendicular to the stacking direction or a cross section including the third axis that is set perpendicular to the stacking direction and perpendicular to the second axis. The multi-layer ceramic capacitor 100 is polished in the direction of the third axis in the former case and in the direction of the second axis in the latter case. From the exposed dielectric layers 11, five layers are selected from each of a center portion, an upper end portion, and a lower end portion as defined in the first axial direction. In the case where the number of the dielectric layers 11 is even, six dielectric layers 11 are selected from the center portion. In each of the selected dielectric layers 11, the thickness is measured at a total of three locations, namely the center portion, the left end portion and the right end portion, and an average value of the measured thicknesses is defined as the thickness of each dielectric layer 11. The average value of the thicknesses of all the selected and evaluated dielectric layers 11 can be defined as the thickness of the dielectric layer 11 in the multi-layer ceramic capacitor 100.

In the example illustrated in FIGS. 1 and 2, since the first axis, which is the stacking direction, is the Z-axis direction, the multi-layer ceramic capacitor 100 is polished along the Y-axis (the third axis), to expose the XZ plane in which the dielectric layers 11 and the internal electrode layers 12 are stacked.

In this case, on the exposed XZ plane, five dielectric layers 11 located at the center along the Z-axis (the first axis), and five dielectric layers 11 located at the upper end and the lower end along the Z-axis (the first axis) are selected. When the number of the dielectric layers 11 is even, six dielectric layers 11 may be selected from the center portion. At this time, the dielectric layers 11 to be selected are selected from within a capacitance section 14.

Then, for each of the selected dielectric layers 11, the thickness is measured at three locations along the X-axis, which is the second axis, the three locations being spaced from an end portion by distances of one-quarter, one-half, and three-quarters of the length of the dielectric layer 11 in the X-axis direction, and an average value of the measured thicknesses is taken as the thickness of the dielectric layer 11. By the same procedure, the thickness is measured for all the selected dielectric layers 11, and the average value of all the selected and evaluated dielectric layers 11 can be used as the thickness of the evaluated dielectric layer 11 in the multi-layer ceramic capacitor 100.

### (3) Internal Electrode Layers

### (3-1) Components Contained in Internal Electrode Layers

As illustrated in FIG. 2, a region where the first internal electrode layers 12a connected to the first external electrode 20a and the second internal electrode layers 12b connected to the second external electrode 20b face each other is a region where an electric capacitance is generated in the multi-layer ceramic capacitor 100. A region where an electric capacitance is generated is herein referred to as a “capacitance section 14”. In other words, the capacitance section 14 is a region where adjacent internal electrode layers face each other, with the dielectric layer 11 that is connected to a different external electrode being interposed between the adjacent internal electrode layers.

A region where the first internal electrode layers 12a connected to the first external electrode 20a face each other in the stacking direction without the second internal electrode layers 12b connected to the second external electrode 20b being interposed between the first internal electrode layers 12a is referred to as a “first end margin 15a” (see FIG. 2). A region where the second internal electrode layers 12b connected to the second external electrode 20b face each other in the stacking direction without the first internal electrode layers 12a connected to the first external electrode 20a being interposed between the second internal electrode layers 12b is referred to as a “second end margin 15b”. Each end margin is a region where internal electrode layers connected to the same external electrode face each other in the stacking direction without internal electrode layers connected to different external electrodes being interposed between the internal electrode layers. The first end margin 15a and the second end margin 15b are regions where internal electrodes of the same potential face each other and do not generate a substantial electric capacitance.

Side margins 16 are regions provided outside the capacitance section 14 in the direction along the Y-axis in the example of FIG. 3 in the third axis perpendicular to the stacking direction and perpendicular to the second axis. In other words, the side margins 16 are outer regions adjacent to the capacitance section 14 when viewed in the stacking direction, and adjacent to the capacitance section 14 on the side where the internal electrode layers 12 are not drawn out. The side margins 16 are also regions where no electrical capacitance is generated.

The internal electrode layers 12 can contain a base metal element as a main component.

The internal electrode layers 12 can contain a component used in the internal electrode layers of a multi-layer ceramic capacitor. The internal electrode layer 12 may primarily contain an alloy containing one or more base metals selected from nickel (Ni), tin (Sn), tungsten (W), and the like, meaning that the alloy may be present in the largest proportion in terms of amount of substance.

The internal electrode layers 12 may contain nickel as a base metal element or may contain nickel as a main component because the internal electrode layers 12 has excellent electrical characteristics and can reduce costs.

The main component of the first internal electrode layers 12a and the main component of the second internal electrode layers 12b may be the same or different. As an example, the main component of both the first internal electrode layers 12a and the second internal electrode layers 12b may be nickel.

### (3-2) Thickness of Internal Electrode Layer

Although the thickness of the internal electrode layer 12 is not particularly limited, from the viewpoint of increasing capacitance by increasing the number of layers while reducing size of the multi-layer ceramic capacitor 100, the thickness is, for example, preferably equal to or less than 0.8 μm, and more preferably equal to or less than 0.6 μm.

Although the lower limit value of the thickness of the internal electrode layer 12 is not particularly limited, the thickness may be equal to or greater than 0.4 μm when internal electrode layers are formed by printing a metal conductive paste by a printing method such as screen printing or gravure printing. In contrast, when internal electrode layers are formed by a thin film process, such as sputtering or vapor deposition, the thickness may be equal to or greater than 0.1 μm, which is thinner than that achievable by the printing method.

When evaluating the thickness of the internal electrode layer 12, the thickness is evaluated on a cross section including the first axis, which is the stacking direction, as in the evaluation of the thickness of the dielectric layer 11. For example, from the viewpoint of ease of polishing and measurement, it is preferable to evaluate the internal electrode layer on a cross section including the second axis, which is set perpendicular to the stacking direction, or a cross section including the third axis, which is set perpendicular to the stacking direction and also perpendicular to the second axis.

From the exposed internal electrode layers 12, five layers are selected from each of a center portion, an upper end portion, and a lower end portion as defined in the first axial direction. In the case where the number of internal electrode layers 12 is even, six internal electrode layers 12 are selected from the center portion. In each of the selected internal electrode layers 12, the thickness is measured at a total of three locations, namely the center portion, the left end portion and the right end portion, and an average value of the measured thicknesses is defined as the thickness of each internal electrode layer 12. The average value of the thicknesses of all the selected and evaluated internal electrode layers 12 can be defined as the thickness of the internal electrode layer 12 in the multi-layer ceramic capacitor 100.

In the example illustrated in FIGS. 1 and 2, since the first axis, which is the stacking direction, is the Z-axis direction, the multi-layer ceramic capacitor 100 is polished along the Y-axis (the third axis), to expose the XZ plane in which the dielectric layers 11 and the internal electrode layers 12 are stacked.

In this case, on the exposed XZ plane, five internal electrode layers 12 located at the center along the Z-axis (the first axis), and five internal electrode layers 12 located at the upper end and the lower end along the Z-axis (the first axis) are selected. When the number of the internal electrode layers 12 is even, six internal electrode layers 12 may be selected from the center portion. At this time, the internal electrode layers 12 to be selected are selected from within the capacitance section 14.

Then, for each of the selected internal electrode layers 12, the thickness is measured at three locations along the X-axis, which is the second axis, the three locations being spaced from an end portion by distances of one-quarter, one-half, and three-quarters of the length of the internal electrode layer 12 in the X-axis direction, and an average value of the measured thicknesses is taken as the thickness of the internal electrode layer 12. By the same procedure, the thickness of all the selected internal electrode layers 12 is measured, and the average value of the thicknesses of all the selected and evaluated internal electrode layers 12 can be used as the thickness of the internal electrode layer 12 in the evaluated multi-layer ceramic capacitor 100.

### [Method of Manufacturing Multi-Layer Ceramic Capacitor]

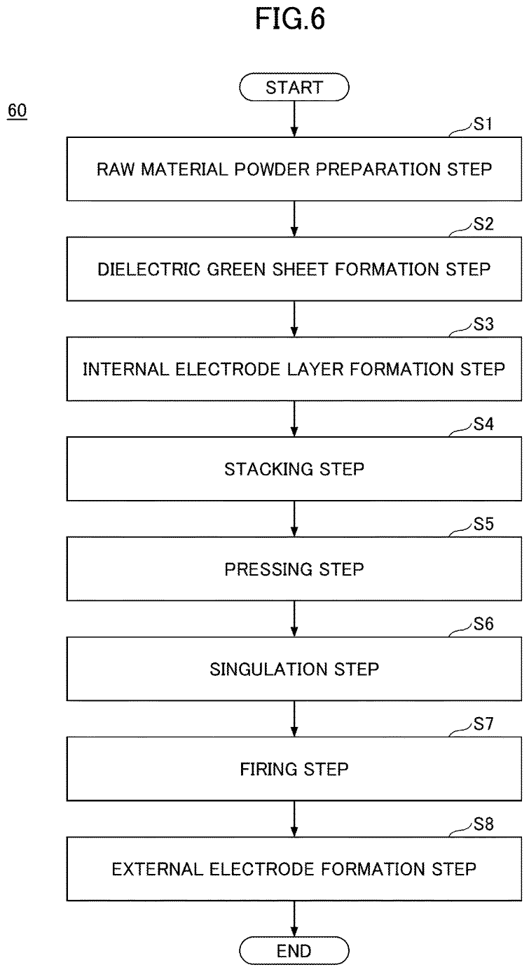

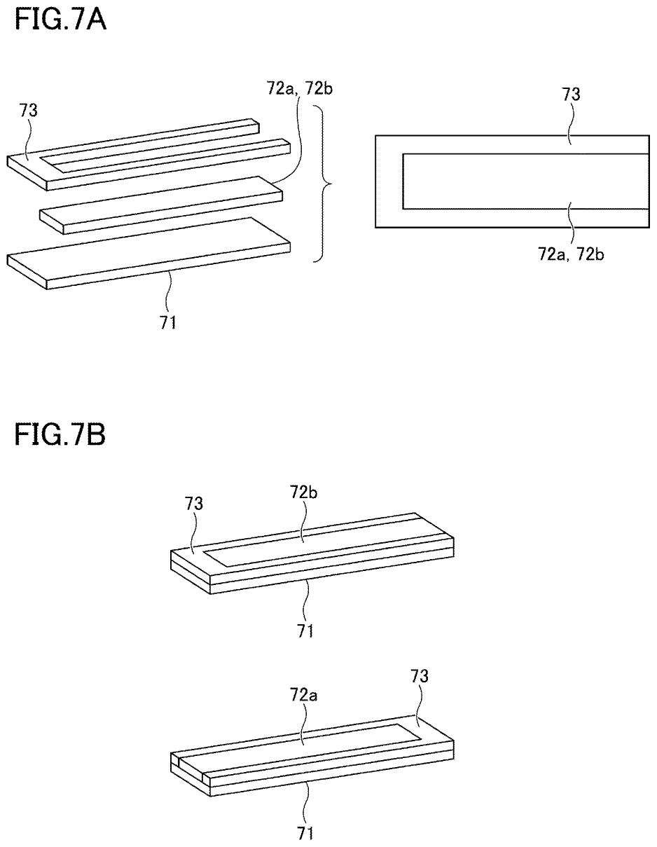

Next, a method of manufacturing the multi-layer ceramic capacitor 100 will be described. FIG. 6 is a flowchart 60 showing a method of manufacturing the multi-layer ceramic capacitor 100. FIGS. 7A and 7B are diagrams illustrating a method of manufacturing the multi-layer ceramic capacitor 100.

The method of manufacturing the multi-layer ceramic capacitor of the present embodiment may include a dielectric green sheet formation step, an internal electrode layer pattern formation step, and a firing step. The method of manufacturing the multi-layer ceramic capacitor of the present embodiment including optional steps other than the above steps will be described below.

### (1) Raw Material Powder Preparation Step (S1)

In the raw material powder preparation step, raw material powder for forming the dielectric layers 11 can be prepared.

The dielectric layers 11 of the multi-layer ceramic capacitor 100 manufactured by the method of manufacturing the multi-layer ceramic capacitor of the present embodiment can contain the dielectric material which is the compound having the perovskite structure and represented by the general formula of ABO_{3-α} (0≤α≤1). The dielectric material, which is the compound having the perovskite structure and represented by the general formula ABO_{3-α} (0≤α≤1), has already been described, and the description the dielectric material will be omitted.

The A-site element (element A) and the B-site element (element B) contained in the dielectric material contained in the dielectric layers 11 are usually contained in the dielectric layers 11 in the form of sintered grains of ABO_{3-α} (0≤α≤1). For example, barium titanate is a tetragonal compound having a perovskite structure and exhibits a high relative dielectric constant. Barium titanate can generally be obtained by reacting a titanium raw material such as titanium dioxide with a barium raw material such as barium carbonate. Various methods for synthesizing a dielectric material that can be used as a main component of the dielectric layer 11 have been known, such as a solid-phase method, a sol-gel method, a hydrothermal method, and the like. In the present embodiment, any of these methods can be employed.

In the raw material powder preparation step, a predetermined additive compound can be added to the dielectric material according to the purpose. Examples of the additive compound include a compound such as an oxide or a carbonate containing one or more elements selected from zirconium (Zr), magnesium (Mg), manganese (Mn), molybdenum (Mo), vanadium (V), chromium (Cr), and rare earth elements, a compound such as an oxide or a carbonate containing one or more elements selected from cobalt (Co), nickel (Ni), lithium (Li), boron (B), sodium (Na), potassium (K), and silicon (Si), and glass containing one or more elements selected from cobalt, nickel, lithium, boron, sodium, potassium, and silicon.

The rare earth element may be one or more selected from scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb).

The raw material powder preferably contains a sintering aid as an additive compound. As the sintering aid, a compound capable of forming second crystal grains containing silicon and element A after firing, in which the content ratio of element A relative to silicon in terms of amount of substance is 1.5 or less, may be used. As the sintering aid, for example, a compound containing one or more kinds of element C selected from manganese and magnesium and silicon may be used. The compound containing element C and silicon may be an oxide, and as the sintering aid, for example, one or more kinds selected from Mg₂SiO₄, Mn₂SiO₄, MnCO₃, and MgO may be used.

The raw material powder can be prepared, for example, by wet mixing the additive compound with the dielectric material, drying and grinding. For example, the raw material powder obtained as described above may be ground as necessary to adjust the particle size, or may be combined with a classification treatment to adjust the particle size. The raw material powder as a ceramic material can be obtained by the above process.

### (2) Dielectric Green Sheet Formation Step (S2)

In the dielectric green sheet formation step, a binder such as polyvinyl butyral (PVB) resin, an organic solvent such as ethanol or toluene, and a plasticizer can be added to the raw material powder obtained in the raw material powder preparation step and mixed by a wet process. In the raw material powder preparation step (S1), a binder or the like may be added at the time of mixing the raw material powder or the like and mixed by a wet process.

In the dielectric green sheet formation step, a dielectric green sheet 71 can be formed by coating the obtained slurry on a substrate by, for example, a die coater method or a doctor blade method and drying the coating. As the substrate, for example, a polyethylene terephthalate (PET) film can be used. The drawings illustrating the dielectric green sheet formation step are omitted.

Thus, in the dielectric green sheet formation step (S2), a dielectric green sheet containing the compound having the perovskite structure and represented by the general formula of ABO_{3-α} (0≤α≤1) or the additive compound can be formed. In addition to the dielectric having a perovskite structure and represented by the general formula, the dielectric green sheet can also contain the additive compound as described above.

### (3) Internal Electrode Layer Formation Step (S3)

The first internal electrode layers 12a and the second internal electrode layers 12b can contain, as a main component, one or more kinds selected from base metals such as nickel (Ni), tin (Sn), tungsten (W), and alloys containing them.

The main component of the first internal electrode layers 12a and the main component of the second internal electrode layers 12b may be the same or different. As an example, the main component of both the first internal electrode layers 12a and the second internal electrode layers 12b may be nickel.

The metal conductive paste for forming the precursors of the first internal electrode layers 12a and the second internal electrode layers 12b can be prepared by kneading a selected main component, an organic binder, and a solvent.

In the step of forming the internal electrode layers, as illustrated in FIG. 7A, a metal conductive paste for forming the internal electrode layers containing an organic binder can be printed on the surface of the dielectric green sheet 71 by screen printing, gravure printing, or the like. As the organic binder, for example, ethyl cellulose (EC) or polyvinyl butyral (PVB) resin can be used. Thus, a first internal electrode layer pattern 72a for the first internal electrode layers 12a or a second internal electrode layer pattern 72b for the second internal electrode layers 12b is arranged on the surface of the dielectric green sheet 71. Various auxiliary agents such as a dispersant or ceramic particles can be added to the metal conductive paste as a co-material. The main component of the ceramic particles is not particularly limited, but is preferably the same as the main component ceramic of the dielectric layer 11. When ceramic particles are added as a co-material, they can be added when kneading the metal conductive paste. The method for forming the internal electrode layers is not limited to printing, and plating, a vacuum deposition method, sputtering, or a CVD method may be used.

A binder such as ethyl cellulose and an organic solvent such as terpineol may be added to a dielectric pattern material obtained in the raw material powder preparation step, and kneaded in a roll mill to obtain a dielectric pattern paste for a reverse pattern layer. Then, as illustrated in FIG. 7A, the dielectric pattern paste may be printed on the dielectric green sheet 71 in a peripheral region where an internal electrode layer pattern is not printed, so that a dielectric pattern 73 may be arranged to fill the step difference with the internal electrode layer pattern. The dielectric green sheet 71 on which the internal electrode layer pattern and the dielectric pattern 73 are printed is referred to as a stacking unit.

### (4) Stacking Step (S4)

In the stacking step, as illustrated in FIG. 7B, stacking units may be stacked in such a manner that the internal electrode layers and the dielectric layers are alternately disposed, and the internal electrode layers are alternately drawn out to a pair of external electrodes with the end edges of the internal electrode layers alternately exposed on both end faces in the longitudinal direction of the dielectric layers. Specifically, the dielectric green sheet 71 on which the first internal electrode layer pattern 72a and the dielectric pattern 73 are printed and the dielectric green sheet 71 on which the second internal electrode layer pattern 72b and the dielectric pattern 73 are printed are alternately stacked. For example, the number of the stacked stacking units may be 100 to 500 layers.

### (5) Pressing Step (S5)

In the pressing step, a predetermined number of cover sheets, for example, two to ten layers, can be stacked on the upper and lower sides of the stack in which the stacking units are stacked and thermally pressed.

### (6) Singulation Step (S6)

In the singulation step, the pressed body is singulated to obtain chips of green-sheet stack. A known method of singulation, such as dicing by a dicer or laser cutting, can be used as appropriate.

### (7) Firing Step (S7)

In the firing step, the singulated stack can be degreased and fired. In the firing step, the degreasing treatment and the firing treatment may be performed continuously or separately. Conditions for degreasing and firing are not particularly limited. The degreasing may be performed in a nitrogen atmosphere of 250° C. to 500° C., for example.

The firing may be performed for five minutes or more and ten hours or less in a weakly oxidizing atmosphere having an oxygen partial pressure of 10⁻¹² atm or greater and 10⁻⁸ atm or less and a temperature range of 1,100° C. or higher and 1,350° C. or lower in a reducing atmosphere. The oxygen partial pressure may be preferably 10⁻¹² atm or greater and 10⁻¹⁰ atm or less.

When the reducing atmosphere is used, one or more kinds selected from hydrogen and carbon monoxide may be used as the reducing gas. The reducing gas may be used as a mixed gas with an inert gas such as nitrogen or a rare gas. The rare gas may be helium or argon.

The temperature range at the time of firing may preferably be 1,150° C. or higher and 1,350° C. or lower. The firing time may preferably be five minutes or higher and less than fifteen minutes.

### (8) External Electrode Formation Step (S8)

In the external electrode formation step, a metal conductive paste is prepared in which a base metal (e.g., nickel) or a metal (e.g., copper) is included as a main component, together with an organic binder; the paste is then applied by screen printing, dipping, or a similar method to form the external electrode layer. A method for forming the external electrode is not limited to printing and dipping, and plating, a vacuum deposition method, sputtering, or a CVD method may be used. The external electrode may be formed by printing and applying a conductive resin paste by screen printing, dipping or the like, and curing the resin. If necessary, a layer of copper, nickel or tin may be formed by plating or the like. Thus, the first external electrode 20a and the second external electrode 20b can be formed. The multi-layer ceramic capacitor 100 can be manufactured by the above steps.

The above steps are examples, and the method of manufacturing the multi-layer ceramic capacitor according to the present embodiment is not limited to the above example. For example, the underlying layer of the external electrode may be formed by providing the underlying layer of the external electrode on the surface of the singulated stack and firing the underlying layer of the external electrode simultaneously with the firing of the ceramic. In this case, in the external electrode formation step after the firing, a layer of copper, nickel, or tin by plating is formed on the underlying layer to form the external electrode.

### Other Embodiment

Although the above embodiment has been described in detail, the present disclosure is not limited to any particular embodiment, and various modifications and alterations are possible within the scope of the claims. For example, although the above embodiment is applied to a multi-layer ceramic capacitor having two terminal electrodes, it may be applied to a multi-layer ceramic capacitor having three or more terminals.

### EXAMPLES

Specific examples will be described below, but the present invention is not limited to these embodiments.

### (1) Evaluation Method

### (1-1) Thickness of Dielectric Layer

The thickness of the dielectric layer was evaluated by the procedure already described. The evaluation results are shown in the column of “Dielectric Layer Thickness” in Table 1.

### (1-2) Average Crystal Grain Size

For the multi-layer ceramic capacitors produced in the respective Examples and Comparative Examples, one section along line B-B in FIG. 1 was exposed. An osmium conductive material was evaporated on the exposed section, and a photograph of crystal grains present in the dielectric layers was taken by SEM observation. Then, the average grain size of the first crystal grains included in the dielectric layers was calculated. In calculating the average grain size, six layers were selected from the center of the exposed dielectric layers 11 in the direction of the first axis, and five layers were selected from the upper end and the lower end, respectively. Then, ten first crystal grains present in each of the selected dielectric layers were selected, and the diameter of a circle having an area equal to the area of the first crystal grain was defined as the grain size (Haywood diameter) of each first crystal grain. Subsequently, the arithmetic mean value of the grain sizes of all the selected first crystal grains was defined as the average crystal grain size of the first crystal grains.

### (1-3) Composition of Second Crystal Grains, Ratio of Length Along First Axis of Second Crystal Grain to Thickness of Dielectric Layer

When SEM observation was performed to evaluate the average crystal grain size, the presence of the second crystal grains 42 in the dielectric layers 11 in the reflected electron image was confirmed by the difference in their luminance. A portion observed to be relatively low in luminance and dark was determined to be the second crystal grains 42.

The composition of the second crystal grains was analyzed using an EDS (energy dispersive X-ray analyzer).

In evaluating the composition of the second crystal grains, six layers were selected from the center of the exposed dielectric layers 11 in the direction of the first axis, and five layers were selected from the upper end and the lower end. Then, two second crystal grains present in each selected dielectric layer were selected. When the number of the second crystal grains included in each dielectric layer was less than two, all the second crystal grains included in the dielectric layers were selected.

In the composition analysis of each second crystal grain, the second crystal grain was analyzed along the diameter of the minimum enclosing circle of the second crystal grain, and the average value of the obtained evaluation results was defined as the composition of the evaluated second crystal grains.

The above composition analysis was performed on all second crystal grains selected from each dielectric layer. Then, the arithmetic average value of the composition of all selected second crystal grains was defined as the composition of the second crystal grain.

From the obtained composition of the second crystal grain, the ratio of barium, magnesium, and manganese relative to silicon in terms of amount of substance was calculated.

The evaluation results are shown in the columns of “Ba/Si element ratio”, “Mg/Si element ratio”, and “Mn/Si element ratio” in the column of “Element ratio of 2nd crystal grains to Si” in Table 1.

For example, “Ba/Si element ratio” indicates the ratio, in the second crystal grain, of barium, which is element A contained in barium titanate, which is a compound having a perovskite structure in the following Examples and Comparative Examples, relative to silicon in terms of amount of substance.

“Mg/Si element ratio” and “Mn/Si element ratio” indicate the ratio of, in the second crystal grain, magnesium and manganese relative to silicon, respectively, in terms of amount of substance.

In addition, the length along the first axis of the second crystal grains included in the dielectric layers 11 in the evaluated cross section was measured. Then, the ratio of the grain having the longest length along the first axis among the second crystal grains included in the dielectric layers 11 to the thickness of the dielectric layer 11 was calculated.

As the thickness of the dielectric layer 11, the evaluation results of “(1-1) Thickness of Dielectric Layer” was used.

The evaluation result is shown in the column of “Ratio of length of second crystal grain along 1st axis with respect to dielectric layer thickness” in Table 1.

### (1-4) Dielectric Constant

The dielectric constant of the multi-layer ceramic capacitors produced in the respective Examples and Comparative Examples was measured.

In the present embodiment, the dielectric constant was measured at a room temperature of 25° C. with a measurement frequency of 1 kHz and a measurement electric field of 0.5 Vrms/μm, i.e., 1 Vrms when the thickness of the dielectric layer was 2 μm.

The measurement results are shown in the column “E” in Table 1. Further, when ε is 3,000 or greater, the multi-layer ceramic capacitor is rated as “∘”, and when ε is less than 3,000, the multi-layer ceramic capacitor is rated as “x”. The result of the rating is shown in the column “Rating”. When the rating is “∘”, it means that the multi-layer ceramic capacitor has a sufficiently high dielectric constant and can enhance capacitance.

### (1-5) Reliability Test

Twenty samples were prepared for the multi-layer ceramic capacitors produced in the respective Examples and Comparative Examples. Then, a reliability test was performed by applying a direct current electric field of 20 V to each of the samples at 150° C. For the twenty samples, MTTF was determined by performing Weibull analysis using the time from the start of voltage application until the insulation resistance dropped by one digit as the failure time. When MTTF was two times or more the standard, it was rated as “A”, when MTTF was 1.5 times or more the standard, it was rated as “B”, and when MTTF was above the standard, it was rated as “C”. When the rating was A, B, or C, it was determined that the dielectric layers with excellent reliability were provided and that the dielectric layers passed the reliability test. It should be noted that A is better than B, and B is better than C in reliability. When MTTF was below the standard, MTTF was rated as “D”, and it was determined that a dielectric layer with inferior reliability was provided.

The evaluation results are shown in the column of “Reliability” in Table 1.

### (1-6) Overall Rating

For the experimental examples in which the dielectric constant was evaluated as “∘”, ratings A to D were assigned according to the results of the reliability tests. In addition, for the experimental example in which the dielectric constant was evaluated as “x”, rating D was assigned.

The ratings are defined such that A represents the best performance, with B, C, and D representing progressively lower performance levels.

When the rating is any of A, B, and C, it means that the material has high capacitance and excellent reliability. When the rating is D, it means that the capacitance is low or that the reliability is inferior.

### (2) Sample Preparation Conditions

### Comparative Examples 1 Through 4

### (2-1) Raw Material Powder Preparation Step

A multi-layer ceramic capacitor was manufactured according to the flowchart 60 shown in FIG. 6.

Specifically, first, a powder of barium titanate, an additive compound, a polyvinyl butyral (PVB) resin, a solvent, and a plasticizer were wet-mixed to obtain a slurry.

In Comparative Examples 1 through 4, the additive compounds were added so that the amounts of Dy₂O₃, MnCO₃, and MgO were 0.75 mol, 1.0 mol, and 0.5 mol, respectively, when the amount of barium titanate was 100 mol. In addition, SiO₂ was added as a Si-containing additive so that the ratios shown in Table 1 were obtained when the amount of barium titanate was 100 mol.

### (2-2) Dielectric Green Sheet Formation Step

The obtained slurry was coated on a substrate film, and the slurry coated on the substrate film was dried to obtain a dielectric green sheet. In Comparative Examples 2 through 4, the thickness of the dielectric green sheet was changed.

### (2-3) Internal Electrode Layer Formation Step

Next, a metal conductive paste for forming an internal electrode layer was obtained by adding ethyl cellulose (EC), polyvinyl butyral (PVB) resin or the like as a binder, a solvent, and a plasticizer to nickel powder as a main component metal element and wet-mixing the mixture. Then, a metal conductive paste was printed on a partial region of the surface of the dielectric green sheet, and an internal electrode layer pattern containing nickel, a base metal element, as a main component was formed in each of the dielectric green sheets.

The stacking units were produced by the above dielectric green sheet formation step and the internal electrode layer formation step. Each obtained stacking unit has a dielectric green sheet and an internal electrode layer pattern formed on the surface of the dielectric green sheet.

### (2-4) Stacking Step

Next, 500 stacking units were stacked to form a stack.

### (2-5) Pressing Step and Singulation Step

Then, after the stack was pressed, it was singulated to obtain chip-like green stacks.

### (2-6) Firing Step

Next, the chip-like green stacks were degreased in a nitrogen atmosphere at 500° C.

On the green stacks after the degreasing treatment, a metal conductive paste containing a metal filler containing nickel as a main component, a composite material, a binder, a solvent, etc. was coated as an underlayer from both end faces to each side face, and dried. Then, the green stack coated with the underlayer of the external electrode was put into a firing furnace and fired.

In the firing step, the green stack was held for 300 seconds at 1,200° C. or 1,300° C., which is the firing temperature shown in Table 1, under a reducing atmosphere of a mixed atmosphere of hydrogen and nitrogen with an oxygen partial pressure of 1.0×10⁻¹⁰ atm. When the temperature was raised, the supplied amount of the green stack and the oxygen partial pressure were adjusted so as not to cause a rapid change in the firing atmosphere due to gas generated from the green stack and not to cause cracks in the fired product.

### (2-7) External Electrode Formation Step

The first external electrode 20a and the second external electrode 20b were formed on the fired stack by plating.

The obtained multi-layer ceramic capacitor had a chip shape of 1.0 mm×0.5 mm×0.5 mm, the thickness of the internal electrode layer 12 was 0.6 μm, and the number of layers was 500. The thickness of the dielectric layer 11 was the value shown in the column of “Dielectric Layer Thickness” in Table 1. The thicknesses of the dielectric layer 11 and the internal electrode layer 12 were evaluated by the procedure already described.

The obtained multi-layer ceramic capacitor was evaluated as described above. The evaluation results are shown in Table 1.

### Example 1

In the raw material powder preparation step, the additive compounds were added so as to be 0.75 mol of Dy₂O₃, 1.0 mol of MnCO₃, and 0.5 mol of MgO when 100 mol of barium titanate was used. Furthermore, the Si-containing additives shown in Table 1 were added so as to be in the ratio shown in Table 1 when 100 mol of barium titanate was used. Specifically, Mg₂SiO₄ was added so as to be in the ratio shown in Table 1 instead of a part of SiO₂.

In the firing step, the firing temperature was 1,200° C. as shown in Table 1. A multi-layer ceramic capacitor was produced and evaluated by the same procedure as Comparative Example 1 except for the above points. The evaluation results are shown in Table 1.

In the multi-layer ceramic capacitor thus obtained, the cover layers, the end margins, the side margins, and the external electrodes were separated to form only a capacitance section, and then the dielectric layer included in the capacitance section was pulverized to powder. When the diffraction line profile of the powder of the dielectric layer thus obtained was measured by an X-ray diffractometer (XRD) using Cu-Kα radiation, diffraction peaks of barium titanate having the perovskite structure and an oxide containing barium and silicon were confirmed. In other words, it was confirmed that the dielectric layer contained the first crystal grains and the second crystal grains. In addition, it was also confirmed by Rietveld analysis that the content of barium titanate corresponding to the first crystal grains was the largest in terms of amount of substance, that is, barium titanate was contained as a main component.

In the following Examples 2 through 11, it was also confirmed by XRD that the dielectric layer contained the first crystal grains as a main component and the second crystal grains as a sub-component.

In order to confirm the composition of the shell portion and the core portion of the first crystal grain of the dielectric layer, a sample for EDS observation by TEM was cut out by focused ion beam machining (FIB). The core-shell structure was confirmed by the method of composition evaluation by EDS, and it was confirmed that the first crystal grain had a core-shell structure and that the shell portion contained Dy, which was a rare earth element. In the following Examples 2 through 11, it was also confirmed that the first crystal grain had a core-shell structure and that the shell portion contained Dy.

### Examples 2 Through 11

In the raw material powder preparation step, the compounds shown in Table 1 were added as Si-containing additives, and the firing temperature was set to the temperature shown in Table 1. The multi-layer ceramic capacitor was prepared and evaluated by the same procedure as in Example 1 except for the above points. The evaluation results are shown in Table 1.

TABLE 1

| | | | | | | | Ratio of | | | | | | | | |
|---|---|---|---|---|---|---|---|---|---|---|---|---|---|---|---|
| | | | | | | | length of | | | | | | | | |
| | | | | | Ave- | | second | | | | | | | | |
| | | | | | rage | | crystal | | | | | | | | |
| | | | | | crystal | | grain | Element | | | | | | | |
| | Amount of | | | | grain | Di- | along 1^{st} | ratio of 2^{nd} | | | | | | | |
| | Si-containing | | | Firing | size | electric | axis with | crystal grains to Si | | | | | Reliability | | |
| | additive added to | | | tem- | of 1^{st} | layer | respect to | Ba/Si | Mg/Si | Mn/Si | ε | | test | | Over- |
| | 100 mol of | | | per- | crystal | thick- | dielectric | ele- | ele- | ele- | Eval- | | Eval- | | all |
| | BaTiO₃ (mol) | | | ature | grains | ness | layer | ment | ment | ment | uation | Rat- | uation | Rat- | Rat- |
| | SiO₂ | Mg₂SiO₄ | Mn₂SiO₄ | (° C.) | (nm) | (μm) | thickness | ratio | ratio | ing | result | ing | result | ing | ing |
| Com- | 1.0 | — | — | 1200 | 210 | 0.60 | 0.25 | 1.91 | 0.01 | 0.02 | 3000 | ○ | 3000 | — | — |
| parative | | | | | | | | | | | | | | | |
| Exa- | | | | | | | | | | | | | | | |
| mple 1 | | | | | | | | | | | | | | | |
| Com- | 1.0 | — | — | 1200 | 210 | 0.50 | 0.32 | 1.87 | 0.01 | 0.01 | 3100 | ○ | 2000 | D | D |
| parative | | | | | | | | | | | | | | | |
| Ex- | | | | | | | | | | | | | | | |
| ample 2 | | | | | | | | | | | | | | | |
| Com- | 1.0 | — | — | 1200 | 220 | 0.41 | 0.37 | 1.89 | 0.01 | 0.02 | 3200 | ○ | 700 | D | D |
| parative | | | | | | | | | | | | | | | |
| Ex- | | | | | | | | | | | | | | | |
| ample 3 | | | | | | | | | | | | | | | |
| Com- | 0.5 | — | — | 1300 | 130 | 0.41 | 0.29 | 1.90 | 0.01 | 0.01 | 2100 | x | 4000 | C | D |
| parative | | | | | | | | | | | | | | | |
| Ex- | | | | | | | | | | | | | | | |
| ample 4 | | | | | | | | | | | | | | | |
| Ex- | 0.8 | 0.2 | — | 1200 | 210 | 0.39 | 0.35 | 1.47 | 0.32 | 0.03 | 3000 | ○ | 3100 | C | C |
| ample 1 | | | | | | | | | | | | | | | |
| Ex- | 0.6 | 0.4 | — | 1200 | 210 | 0.40 | 0.35 | 1.25 | 0.55 | 0.02 | 3200 | ○ | 3700 | C | C |
| ample 2 | | | | | | | | | | | | | | | |
| Ex- | 0.4 | 0.6 | — | 1200 | 200 | 0.41 | 0.35 | 0.79 | 1.10 | 0.01 | 3100 | ○ | 3900 | C | C |
| ample 3 | | | | | | | | | | | | | | | |
| Ex- | 0.2 | 0.8 | — | 1210 | 200 | 0.40 | 0.38 | 0.46 | 1.38 | 0.02 | 3200 | ○ | 5000 | B | B |
| ample 4 | | | | | | | | | | | | | | | |
| Ex | — | 1.0 | — | 1220 | 190 | 0.39 | 0.37 | 0.18 | 1.81 | 0.01 | 3000 | ○ | 6200 | A | A |
| ample 5 | | | | | | | | | | | | | | | |
| Ex- | 0.8 | — | 0.2 | 1200 | 210 | 0.40 | 0.37 | 1.47 | 0.02 | 0.41 | 3100 | ○ | 3300 | C | C |
| ample 6 | | | | | | | | | | | | | | | |
| Ex- | 0.6 | — | 0.4 | 1200 | 210 | 0.39 | 0.36 | 1.27 | 0.01 | 0.58 | 3100 | ○ | 3700 | C | C |
| ample 7 | | | | | | | | | | | | | | | |
| Ex- | 0.4 | — | 0.6 | 1200 | 210 | 0.40 | 0.35 | 0.81 | 0.03 | 1.08 | 3100 | ○ | 4200 | C | C |
| ample 8 | | | | | | | | | | | | | | | |
| Ex- | 0.2 | — | 0.8 | 1210 | 200 | 0.41 | 0.36 | 0.32 | 0.01 | 1.44 | 3100 | ○ | 5000 | B | B |
| ample 9 | | | | | | | | | | | | | | | |
| Ex- | — | — | 1.0 | 1220 | 190 | 0.40 | 0.36 | 0.13 | 0.01 | 1.78 | 3000 | ○ | 6100 | A | A |
| ample 10 | | | | | | | | | | | | | | | |
| Ex- | — | 0.5 | 0.5 | 1220 | 190 | 0.40 | 0.36 | 0.12 | 0.94 | 0.81 | 3000 | ○ | 6000 | A | A |
| ample 11 | | | | | | | | | | | | | | | |

In Comparative Examples 2 through 4 in which the thickness of the dielectric layer was reduced in comparison with Comparative Example 1, the content ratio of, in terms of amount of substance, element A of a compound having the perovskite structure relative to silicon was 1.5 or more in the second crystal grains included in the dielectric layers. In addition, in the foregoing Comparative Examples, the rating of the dielectric constant was “x” or the rating of the reliability test was D, which confirmed that the dielectric constant was inferior. Therefore, in the conventional design, the limit value of the dielectric thickness was 0.6 μm, and it was shown that it was difficult to further reduce the thickness of a dielectric.

In comparison with Comparative Example 3, when the amount of Si added was reduced with the same thickness of the dielectric layer, the sinterability was greatly degraded. Therefore, it was necessary to raise the calcination temperature, but it was found that even in Comparative Example 4, when the calcination temperature was raised from 1,200° C. to 1,300° C., the dielectric constant did not reach the desired level due to the inferior crystallinity. As described above, when the thickness of a dielectric is less than 0.6 μm, in the second crystal grain included in the dielectric layer, when the content ratio of, in terms of amount of substance, element A of the compound having the perovskite structure relative to silicon is 1.5 or more, the rating of the reliability test is D. When the amount of Si added was reduced in an attempt to improve this, the reliability was improved, but instead the dielectric constant was degraded and became “x”, and it was confirmed that the evaluation of either the reliability or the dielectric constant is low by the conventional method.

As shown in Table 1, in Examples 1 through 5, Mg₂SiO₄ was added instead of a part or all of SiO₂. In Examples 6 through 10, Mn₂SiO₄ was added instead of a part or all of SiO₂. In Example 11, both Mg₂SiO₄ and Mn₂SiO₄ were added instead of all of SiO₂. In the above Examples, it was confirmed that the second crystal grains included in the dielectric layers contain silicon and element A, and that the content ratio of, in terms of amount of substance, element A in the compound having the perovskite structure relative to silicon was 1.5 or less. In Examples 1 through 11, it was confirmed that the MTFE in the reliability test was longer than that in Comparative Example 1, and that the rating was either A, B, or C.

In other words, it was confirmed that the multi-layer ceramic capacitors of Examples 1 through 11 had excellent reliability of the dielectric layers.

In particular, in Examples 4, 5, 9, 10, and 11, it was confirmed that the result of the reliability test was 1.5 times or more of the life of Comparative Example 1, and that the evaluation rating was either A or B.

In Examples 4 and 5, Mg₂SiO₄ is added in an amount of 0.7% or more relative to the content of, in terms of substance amount, element A in the compound having the perovskite structure.

In Examples 9 and 10, Mn₂SiO₄ was added in an amount of 0.7% or more relative to the content ratio of, in terms of substance amount, element A in the compound having the perovskite structure.

In Example 11, both Mg₂SiO₄ and Mn₂SiO₄ were added.

In particular, in Examples 5 and 10, in which Mg₂SiO₄ or Mn₂SiO₄ was added more than 0.8% relative to the content ratio of, in terms of substance amount, element A in the compound having a perovskite structure, and in Example 11, in which both Mg₂SiO₄ and Mn₂SiO₄ were added, it was confirmed that the result of the reliability test was two times or more of the life of Comparative Example 1 and that the rating was A.

Aspects of the present disclosure are, for example, as follows.

<1> A multi-layer ceramic electronic component, including:
a plurality of dielectric layers stacked along a first axis; and
a plurality of internal electrode layers disposed between respective adjacent ones of the plurality of dielectric layers along the first axis, wherein
the plurality of dielectric layers include
   first crystal grains containing a compound that contains an element A and an element B and has a perovskite structure, the compound being represented by a general formula of ABO_{3-α} (0≤α≤1), the first crystal grains being a main component of the plurality of dielectric layers; and
second crystal grains containing silicon and the element A, a content ratio of, in terms of amount of substance, the element A relative to silicon being 1.5 or less, the second crystal grains being a sub-component of the plurality of dielectric layers, and
the plurality of internal electrode layers contain a base metal element as a main component, the main component of the plurality of internal electrode layers differing from the main component of the plurality of dielectric layers.

<2> The multi-layer ceramic electronic component according to <1>, wherein a second crystal grain of the second crystal grains included in the plurality of dielectric layers has a length along the first axis that is equal to or greater than one-third of a thickness of a dielectric layer of the plurality of dielectric layers.

<3> The multi-layer ceramic electronic component according to <1> or <2>, wherein a thickness of a dielectric layer of the plurality of dielectric layers is less than 0.6 μm.

<4> The multi-layer ceramic electronic component according to any one of <1> to <4>, wherein in the second crystal grains, a content ratio of, in terms of amount of substance, the element A relative to silicon is 0.5 or less.

<5> The multi-layer ceramic electronic component according to any one of <1> to <4>, wherein the second crystal grains contain one or more elements selected from manganese and magnesium.

<6> The multi-layer ceramic electronic component according to any one of <1> to <5>, wherein a first crystal grain of the first crystal grains includes a core portion containing the compound having the perovskite structure and a shell portion surrounding the core portion and containing a rare earth element.

<7> The multi-layer ceramic electronic component according to any one of <1> to <6>, wherein the plurality of dielectric layers contain barium titanate as the compound having the perovskite structure.

What is claimed is:

1. A multi-layer ceramic electronic component, comprising:
a plurality of dielectric layers stacked along a first axis; and
a plurality of internal electrode layers disposed between respective adjacent ones of the plurality of dielectric layers along the first axis, wherein
the plurality of dielectric layers include
first crystal grains containing a compound that contains an element A and an element B and has a perovskite structure, the compound being represented by a general formula of ABO_{3-α} (0≤α≤1), the first crystal grains being a main component of the plurality of dielectric layers; and
second crystal grains containing silicon and the element A, a content ratio of, in terms of amount of substance, the element A relative to silicon being 1.5 or less, the second crystal grains being a sub-component of the plurality of dielectric layers, and
the plurality of internal electrode layers contain a base metal element as a main component, the main component of the plurality of internal electrode layers differing from the main component of the plurality of dielectric layers.

2. The multi-layer ceramic electronic component according to claim 1, wherein
a second crystal grain of the second crystal grains included in the plurality of dielectric layers has a length along the first axis that is equal to or greater than one-third of a thickness of a dielectric layer of the plurality of dielectric layers.

3. The multi-layer ceramic electronic component according to claim 1, wherein
a thickness of a dielectric layer of the plurality of dielectric layers is less than 0.6 μm.

4. The multi-layer ceramic electronic component according to claim 1, wherein
in the second crystal grains, a content ratio of, in terms of amount of substance, the element A relative to silicon is 0.5 or less.

5. The multi-layer ceramic electronic component according to claim 1, wherein
the second crystal grains contain one or more elements selected from manganese and magnesium.

6. The multi-layer ceramic electronic component according to claim 1, wherein
a first crystal grain of the first crystal grains includes a core portion containing the compound having the perovskite structure and a shell portion surrounding the core portion and containing a rare earth element.

7. The multi-layer ceramic electronic component according to claim 1, wherein
the plurality of dielectric layers contain barium titanate as the compound having the perovskite structure.
